(19) United States
(12) Patent Application Publication
(10) Pub. No.: US 2025/0129717 A1
(43) Pub. Date: Apr. 24, 2025

(54) QUANTITATIVE PREDICTION METHOD FOR GAS CONTENT OF DEEP MARINE SHALE

(71) Applicants: Southwest Petroleum University, Chengdu (CN); Sinopec Southwest Petroleum Bureau Co., Ltd, Chengdu (CN); PetroChina Zhejiang Oilfield Company, Hangzhou (CN)

(72) Inventors: Xinyang He, Chengdu (CN); Kun Zhang, Chengdu (CN); Hulin Niu, Chengdu (CN); Chengzao Jia, Chengdu (CN); Yan Song, Chengdu (CN); Zhenxue Jiang, Chengdu (CN); Shu Jiang, Chengdu (CN); Xueying Wang, Chengdu (CN); Nanxi Zhang, Chengdu (CN); Xiaoxia Dong, Chengdu (CN); Jun Dong, Chengdu (CN); Ruisong Li, Chengdu (CN); Tong Wang, Chengdu (CN); Pu Huang, Chengdu (CN); Jiasui Ouyang, Chengdu (CN); Xingmeng Wang, Chengdu (CN); Shoucheng Xu, Chengdu (CN); Hanbing Zhang, Hangzhou (CN); Yubing Ji, Hangzhou (CN); Lei Chen, Chengdu (CN); Xuefei Yang, Chengdu (CN); Fengli Han, Chengdu (CN); Weishi Tang, Chengdu (CN); Jingru Ruan, Chengdu (CN); Hengfeng Gou, Chengdu (CN); Lintao Li, Chengdu (CN); Yipeng Liu, Chengdu (CN); Ping Liu, Chengdu (CN)

(21) Appl. No.: 18/918,078

(22) Filed: Oct. 17, 2024

(30) Foreign Application Priority Data
Oct. 24, 2023 (CN) 202311386727.3

(51) Int. Cl. E21B 49/00

(52) U.S. Cl. CPC E21B 49/008; E21B 2200/22

(57) ABSTRACT

A quantitative prediction method for gas content of deep marine shale includes: obtaining raw data of known wells; establishing relationship formulas between pore specific surface areas and adsorbed gas contents of a known well in an area as an adsorbed gas content quantitative prediction model; establishing relationship formulas between pore volumes and free gas contents of the known well as a free gas content quantitative prediction model; summing the adsorbed gas contents and corresponding free gas contents to obtain total gas contents; calculating adsorbed gas contents, free gas contents and total gas contents of the known wells; drawing a predicted adsorbed gas content contour map, a predicted free gas content contour map and a predicted total gas content contour map; and reading an adsorbed gas content, a free gas content and a total gas content of an unknown well in the area from the above contour maps.

### CROSS-REFERENCE TO RELATED APPLICATION

This application claims priority to Chinese Patent Application No. 20231138672.7, filed on Oct. 24, 2023, which is herein incorporated by reference in its entirety.

### TECHNICAL FIELD

The disclosure relates to the field of shale gas extraction technologies, and more particularly to a quantitative prediction method for gas content of a deep marine shale.

### BACKGROUND

In recent years, China has launched exploration and development work of shale gas, and has basically mastered main technologies for exploration and development of medium and shallow shale gas. However, the exploration and development of deep marine shale gas is still in its infancy. Deep marine shale gas resources have huge potential and are an important oil replacement energy source in China. Therefore, how to select calculation parameters of gas content in deep marine shale and quantitatively predict and evaluate the gas content in the deep marine shale is crucial.

Previous studies have shown that the deep marine shale gas can be divided into adsorbed gas and free gas according to its occurrence state. A correlation analysis method is currently mainly used for quantitatively predicting the gas content in the deep marine shale. First, various influencing factors of an adsorbed gas content and various influencing factors of a free gas content are identified, and a prediction model between the adsorbed gas content and the various influencing factors thereof, and a prediction model between the free gas content and the various influencing factors thereof are established. According to the prediction models, the adsorbed gas content and the free gas content are calculated to calculate a total gas content, to thereby achieve a purpose of quantitative prediction. However, due to the large number of influencing factors of the adsorbed gas content and the free gas content, this method requires a large amount of experimental data (such as a total organic carbon content abbreviated as TOC content, a porosity, a water saturation, a clay mineral content, a formation temperature and a formation pressure) to support, and does not eliminate the mutual influence between the influencing factors. The method is costly and has low accuracy.

### SUMMARY

Aiming at problems that current prediction methods for gas content of deep marine shale have a large amount of used data, complex process and low prediction accuracy, the disclosure provides a quantitative prediction method for shale gas content in deep marine.

The quantitative prediction method for shale gas content provided by the disclosure includes:
S1, obtaining raw data; where the raw data includes adsorbed gas contents, free gas contents, pore specific surface areas and pore volumes of shale samples at different sampling depths of a known well in an area; and a depth difference between two adjacent sampling depths hᵢ₋₁ and hᵢ of the different sampling depths is 10 meters (m), and i≥2;
where each of the adsorbed gas contents is obtained by using a methane adsorption isotherm experiment;
where each of the total gas contents is obtained by using an on-site testing method based on pressure-holding coring, and each of the free gas contents is a difference between the total gas content and a corresponding one of the adsorbed gas contents; and
where the pore specific surface areas and the pore volumes are obtained by using at least one selected from the group consisting of a pore structure characterization method based on carbon dioxide adsorption experiment, a pore structure characterization method based on nitrogen adsorption experiment and a pore structure characterization method based on high-pressure mercury injection experiment;
S2, establishing, based on the raw data, relationship formulas between the pore specific surface areas and the adsorbed gas contents of the known well as an adsorbed gas content quantitative prediction model; where the step S2 specifically includes:
   S21, expressing the pore specific surface areas as x, and expressing the adsorbed gas contents as y, to form a first discrete series [xᵢ, yᵢ]; where xᵢ represents a pore specific surface area of a shale sample at an i^{th} sampling depth hᵢ of the known well, and yᵢ represents an adsorbed gas content of the shale sample at the i^{th} sampling depth hᵢ of the known well;
   S22, obtaining linear equations of straight lines passing through every two adjacent points (xᵢ₋₁, yᵢ₋₁) and (xᵢ, yᵢ) as absorbed gas content prediction formulas corresponding to different burial depths; where the step S22 specifically includes:
      (1) expressing a first linear equation of a first straight line passing through two points (x₁, y₁) and (x₂, y₂) as y−y₁=k₁(x−x₁), substituting the two points (x₁, y₁) and (x₂, y₂) into the first linear equation y−y₁=k₁(x−x₁) to obtain a first slope k₁, and obtaining the first linear equation of the first straight line passing through the two points (x₁, y₁) and (x₂, y₂) based on the first slope, expressed as a formula 1 as follows:

$$y = {k}_{1} ( x - {x}_{1} ) + {y}_{1} ; \qquad ( formula 1 )$$

where the formula 1 is an adsorbed gas content prediction formula corresponding to a first burial depth range of h₁ to h₂;
(2) expressing a second linear equation of a second straight line passing through two points (x₂, y₂) and (x₃, y₃) as y−y₂=k₂(x−x₂), substituting the two points (x₂, y₂) and (x₃, y₃) into the second linear equation y−y₂=k₂(x−x₂) to obtain a second slope k₂, and obtaining the second linear equation of the second straight line passing through the two points (x₂, y₂) and (x₃, y₃) based on the second slope, expressed as a formula 2 as follows:

$$y = {k}_{2} ( x - {x}_{2} ) + {y}_{2} ; \qquad ( formula 2 )$$

where the formula 2 is an adsorbed gas content prediction formula corresponding to a second burial depth range of h₂ to h₃;
(3) expressing a third linear equation of a third straight line passing through two points (x₃, y₃) and (x₄, y₄) as y−y₃=k₃(x−x₃), substituting the two points (x₃, y₃) and (x₄, y₄) into the third linear equation y−y₃=k₃(x−x₃) to obtain a third slope k₃, obtaining the third linear equation of the third straight line passing through the two points (x₃, y₃) and (x₄, y₄) based on the third slope, expressed as a formula 3 as follows:

$$y = {k}_{3} ( x - {x}_{3} ) + {y}_{3} ; \qquad ( formula 3 )$$

where the formula 3 is an adsorbed gas content prediction formula corresponding to a third burial depth range of h₃ to h₄; and
(4) expressing a (i−1)^{th} linear equation of a (i−1)^{th} straight line passing through every two adjacent points (xᵢ₋₁, yᵢ₋₁) and (xᵢ, yᵢ) as y−yᵢ₋₁=kᵢ₋₁(x−xᵢ₋₁), wherein i≥5, substituting the two points (xᵢ₋₁, yᵢ₋₁) and (xᵢ, yᵢ) into the (i−1)^{th} linear equation y−yᵢ₋₁=kᵢ₋₁(x−xᵢ₋₁) to obtain a (i−1)^{th} slope kᵢ₋₁, and obtaining the (i−1)^{th} linear equation of the (i−1)^{th} straight line passing through the two adjacent points (xᵢ₋₁, yᵢ₋₁) and (xᵢ, yᵢ) based on the (i−1)^{th} slope, expressed as follows:

$$y = {k}_{i - 1} ( x - {x}_{i - 1} ) + {y}_{i - 1} ;$$

where the (i−1)^{th} linear equation y=kᵢ₋₁(x−xᵢ₋₁)+yᵢ₋₁ is an adsorbed gas content prediction formula corresponding to (i−1)^{th} a burial depth range of hᵢ₋₁ to hᵢ;
S23, predicting, according to the absorbed gas content prediction formulas corresponding to the different burial depths, absorbed gas contents at the different burial depths in segment by segment; and
S24, averaging the adsorbed gas contents at the different burial depths predicted in the step S23 to obtain an adsorbed gas content Qₐ₁ of the known well;
S3, establishing relationship formulas between the pore volumes and the free gas contents of the known well as a free gas content quantitative prediction model; where the step S3 specifically includes:
   expressing the pore volumes as u, and expressing the free gas contents as v, to form a second discrete series [uᵢ, vᵢ]; where uᵢ represents a pore volume of the shale sample at the i^{th} sampling depth hᵢ, and vᵢ represents a free gas content of the shale sample at the i^{th} sampling depth hᵢ; and
   obtaining a free gas content Q_{b1} of the known well according to a same method of the steps S22-S24;
S4, summing the adsorbed gas content Qₐ₁ and the free gas content Q_{b1} to obtain a total gas content Q_{total 1} of of the known well;
S5, performing the steps S1-S4 to determine an adsorbed gas content, a free gas content and a total gas content of each of other known wells in the area, to thereby obtain an adsorbed gas content Qₐᵢ, a free gas content Q_{bi} and a total gas content Q_{total i} of each known well in the area; and
S6, drawing a contour map of predicted adsorbed gas content, a contour map of predicted free gas content and a contour map of predicted total gas content of the area according to the adsorbed gas content Qₐᵢ, the free gas content Q_{bi} and the total gas content Q_{total i} of each known well in the area obtained in the step S5; reading a predicted adsorbed gas content Qₐₓ, a predicted free gas content Q_{bx} and a predicted total gas content Q_{total x} of an unknown well in the area from the contour map of predicted adsorbed gas content, the contour map of predicted free gas content and the contour map of predicted total gas content.

In an embodiment, in the step S6, after the reading a predicted adsorbed gas content Qₐₓ, a predicted free gas content Q_{bx} and a predicted total gas content Q_{total x} of an unknown well in the area from the contour map of predicted adsorbed gas content, the contour map of predicted free gas content and the contour map of predicted total gas content, the step S6 further includes:
summing the predicted adsorbed gas content Qₐₓ and the predicted free gas content Q_{bx} of the unknown well in the area to obtain a calculated total gas content Q_{ab} of the unknown well in the area; and averaging the calculated total gas content Q_{ab} and the predicted total gas content Q_{total x} as a total gas content of the unknown well in the area.

In an embodiment, the embodiment of the disclosure provides a quantitative prediction method for shale gas content, including:
S1, performing a methane adsorption isotherm experiment to obtain adsorbed gas contents of shale samples at different sampling depths of a known well in an area, performing an on-site testing method based on pressure-holding coring to obtain total gas contents of the shale samples at the different sampling depths of the known well in the area, calculating differences between the total gas contents and corresponding adsorbed gas contents to obtain free gas contents of the shale samples at the different sampling depths of the known well in the area, and performing at least one selected from the group consisting of a pore structure characterization method based on carbon dioxide adsorption experiment, a pore structure characterization method based on nitrogen adsorption experiment and a pore structure characterization method based on high-pressure mercury injection experiment to obtain pore specific surface areas and pore volumes of the shale samples at the different sampling depths of the known well in the area; where a depth difference between two adjacent sampling depths hᵢ₋₁ and hᵢ of the different sampling depths is 10 m, and i≥2;
S2, establishing relationship formulas between the pore specific surface areas and the adsorbed gas contents of the known well as an adsorbed gas content quantitative prediction model; where the step S2 specifically includes:
   S21, expressing the pore specific surface areas as x, and expressing the adsorbed gas contents as y, to form a first discrete series [xᵢ, yᵢ]; where xᵢ represents a pore specific surface area of a shale sample at an i^{th} sampling depth hᵢ of the known well, and yᵢ represents an adsorbed gas content of the shale sample at the i^{th} sampling depth hᵢ of the known well;
   S22, obtaining linear equations of straight lines passing through every two adjacent points (xᵢ₋₁, yᵢ₋₁) and (xᵢ, yᵢ) as absorbed gas content prediction formulas corresponding to different burial depths; where the step S22 specifically includes:
      (1) expressing a first linear equation of a first straight line passing through two points (x₁, y₁) and (x₂, y₂) as y−y₁=k₁(x−x₁), substituting the two points (x₁, y₁) and (x₂, y₂) into the first linear equation y−y₁=k₁(x−x₁) to obtain a first slope k₁, and obtaining the first linear equation of the first straight line passing through the two points (x₁, y₁) and (x₂, y₂) based on the first slope, expressed as a formula 1 as follows:

$$y = {k}_{1} ( x - {x}_{1} ) + {y}_{1} ; \qquad ( formula 1 )$$

where the formula 1 is an adsorbed gas content prediction formula corresponding to a first burial depth range of h₁ to h₂;
(2) expressing a second linear equation of a second straight line passing through two points (x₂, y₂) and (x₃, y₃) as y−y₂=k₂(x−x₂), substituting the two points (x₂, y₂) and (x₃, y₃) into the second linear equation y−y₂=k₂(x−x₂) to obtain a second slope k₂, and obtaining the second linear equation of the second straight line passing through the two points (x₂, y₂) and (x₃, y₃) based on the second slope, expressed as a formula 2 as follows:

$$y = {k}_{2} ( x - {x}_{2} ) + {y}_{2} ; \qquad ( formula 2 )$$

where the formula 2 is an adsorbed gas content prediction formula corresponding to a second burial depth range of h₂ to h₃;
(3) expressing a third linear equation of a third straight line passing through two points (x₃, y₃) and (x₄, y₄) as y−y₃=k₃(x−x₃), substituting the two points (x₃, y₃) and (x₄, y₄) into the third linear equation y−y₃=k₃(x−x₃) to obtain a third slope k₃, obtaining the third linear equation of the third straight line passing through the two points (x₃, y₃) and (x₄, y₄) based on the third slope, expressed as a formula 3 as follows:

$$y = {k}_{3} ( x - {x}_{3} ) + {y}_{3} ; \qquad ( formula 3 )$$

where the formula 3 is an adsorbed gas content prediction formula corresponding to a third burial depth range of h₃ to h₄; and
(4) expressing a (i−1)^{th} linear equation of a (i−1)^{th} straight line passing through every two adjacent points (xᵢ₋₁, yᵢ₋₁) and (xᵢ, yᵢ) as y−yᵢ₋₁=kᵢ₋₁(x−xᵢ₋₁), wherein i≥5, substituting the two points (xᵢ₋₁, yᵢ₋₁) and (xᵢ, yᵢ) into the (i−1)^{th} linear equation y−yᵢ₋₁=kᵢ₋₁(x−xᵢ₋₁) to obtain a (i−1)^{th} slope kᵢ₋₁, and obtaining the (i−1)^{th} linear equation of the (i−1)^{th} straight line passing through the two adjacent points (xᵢ₋₁, yᵢ₋₁) and (xᵢ, yᵢ) based on the (i−1)^{th} slope, expressed as follows:

$$y = {k}_{i - 1} ( x - {x}_{i - 1} ) + {y}_{i - 1} ;$$

where the (i−1)^{th} linear equation y=kᵢ₋₁(x−xᵢ₋₁)+yᵢ₋₁ is an adsorbed gas content prediction formula corresponding to (i−1)^{th} a burial depth range of hᵢ₋₁ to hᵢ;
S23, predicting, according to the absorbed gas content prediction formulas corresponding to the different burial depths, absorbed gas contents at the different burial depths in segment by segment; and
S24, averaging the adsorbed gas contents at the different burial depths predicted in the step S23 to obtain an adsorbed gas content Qₐ₁ of the known well;
S3, establishing relationship formulas between the pore volumes and the free gas contents of the known well as a free gas content quantitative prediction model; where the step S3 specifically includes:
   expressing the pore volumes as u, and expressing the free gas contents as v, to form a second discrete series [uᵢ, vᵢ]; where uᵢ represents a pore volume of the shale sample at the i^{th} sampling depth hᵢ, and vᵢ represents a free gas content of the shale sample at the i^{th} sampling depth hᵢ; and
   obtaining a free gas content Q_{b1} of the known well according to a same method of the steps S22-S24;
S4, summing the adsorbed gas content Qₐ₁ and the free gas content Q_{b1} to obtain a total gas content Q_{total 1} of of the known well;
S5, performing the steps S1-S4 to determine an adsorbed gas content, a free gas content and a total gas content of each of other known wells in the area, to thereby obtain an adsorbed gas content Qₐᵢ, a free gas content Q_{bi} and a total gas content Q_{total i} of each known well in the area; and
S6, drawing a contour map of predicted adsorbed gas content, a contour map of predicted free gas content and a contour map of predicted total gas content of the area according to the adsorbed gas content Qₐᵢ, the free gas content Q_{bi} and the total gas content Q_{total i} of each known well in the area obtained in the step S5; reading a predicted adsorbed gas content Qₐₓ, a predicted free gas content Q_{bx} and a predicted total gas content Q_{total x} of an unknown well in the area from the contour map of predicted adsorbed gas content, the contour map of predicted free gas content and the contour map of predicted total gas content; summing the predicted adsorbed gas content Qₐₓ and the predicted free gas content Q_{bx} of the unknown well in the area to obtain a calculated total gas content Q_{ab} of the unknown well in the area; and averaging the calculated total gas content Q_{ab} and the predicted total gas content Q_{total x} as a total gas content of the unknown well in the area.

In an exemplary embodiment, the quantitative prediction method for gas content of a deep marine shale further includes:
dividing the unknown wells in the area into three levels according to the total gas content of each unknown well in the area, specifically including:
   determining an unknown well with a total gas content greater than a first threshold as a first level gas-bearing area;
   determining an unknown well with a total gas content greater than a second threshold and smaller than the first threshold as a second level gas-bearing area; and
   determining an unknown well with a total gas content smaller than the second threshold as a third level gas bearing area; and
developing shale gas in the unknown well in the area in an order of the first gas-bearing area, the second gas-bearing area and the third gas-bearing area.

Specifically, the first threshold is 11 cubic meters per ton (m³/t), and the second threshold is 9 m³/t.

Compared to the related art, beneficial effects of the disclosure are as follows.
(1) The prediction method of the disclosure takes the shale pore structure as a starting point to establish the relationship formulas between pore specific surface area and adsorbed gas content as the adsorbed gas content prediction model, and establish the relationship formulas between pore volume and free gas content as the free gas content prediction model. A sum of the adsorbed gas content and the free gas content is the total gas content of the shale.
(2) The prediction method of the disclosure does not require the use of a large amount of experimental data (such as a TOC content, a porosity, a water saturation, a clay mineral content, a formation temperature and a formation pressure), which is a simpler prediction method, overcomes the problems that the current prediction methods have a large amount of used data, large amount of calculation, and complex process. In addition, the prediction method of the disclosure has no mutual influence between the various influencing factors, and the accuracy is higher.

Other advantages, purposes and features of the disclosure are embodied in part through the following description, and in part will be understood by those skilled in the art through study and practice of the disclosure.

### BRIEF DESCRIPTION OF DRAWINGS

FIG. 1 illustrates a contour map of predicted adsorbed gas contents of gas-bearing intervals in an X area according to an embodiment of the disclosure.

FIG. 2 illustrates a contour map of predicted free gas contents of gas-bearing intervals in the X area according to an embodiment of the disclosure.

FIG. 3 illustrates a contour map of predicted total gas contents of gas-bearing intervals in the X area according to an embodiment of the disclosure.

### DETAILED DESCRIPTION OF EMBODIMENTS

Embodiments of the disclosure are described in conjunction with drawings. It should be understood that the described embodiments are merely used for describing and explaining the disclosure, and are not used to limit the disclosure.

In step S1, raw data is obtained, the raw data includes adsorbed gas contents, free gas contents, pore specific surface areas and pore volumes of shale samples at different sampling depths of a known well in an area. For example, Table 1 shows raw experimental data of a L1 well in an X area.

The adsorbed gas contents are obtained by using a methane adsorption isotherm experiment.

The total gas contents are obtained by using an on-site testing method based on pressure-holding coring, and each of the free gas contents is a difference between the total gas content and a corresponding one of the adsorbed gas contents.

The pore specific surface areas and the pore volumes are obtained by using at least one selected from the group consisting of a pore structure characterization method based on carbon dioxide adsorption experiment, a pore structure characterization method based on nitrogen adsorption experiment and a pore structure characterization method based on high-pressure mercury injection experiment.

TABLE 1
Raw experimental raw data of the L1 well in the X area

| Sampling | Adsorbed gas content | Free gas | Pore specific surface area | Pore |
|---|---|---|---|---|
| depth | (milliliter per gram | content | (square micrometer per gram | volume |
| (m) | abbreviated as mL/g) | (mL/g) | abbreviated as μm²/g | (mL/g) |
| 3680 | 2.32 | 6.34 | 168.8013742 | 0.22177386 |
| 3690 | 1.96 | 5.69 | 150.9857815 | 0.20228551 |
| 3700 | 2.07 | 6.06 | 155.5690009 | 0.23259485 |
| 3710 | 2.11 | 6.62 | 158.8504315 | 0.24244343 |
| 3720 | 2.56 | 7.03 | 197.3862395 | 0.27527079 |
| 3730 | 2.30 | 5.40 | 178.3853437 | 0.18039102 |
| 3740 | 1.99 | 6.38 | 156.4011937 | 0.23142291 |
| 3750 | 2.28 | 6.87 | 167.0308136 | 0.26120689 |
| 3760 | 2.65 | 6.79 | 217.5375609 | 0.25062694 |
| 3770 | 2.44 | 7.27 | 192.1446012 | 0.32218894 |

In step S2, relationship formulas between the pore specific surface areas and the adsorbed gas contents of the known well are established as an adsorbed gas content quantitative prediction model. The pore specific surface areas are expressed as x, and the adsorbed gas contents are expressed as y, to thereby form a first discrete series [xᵢ, yᵢ].
a. A linear equation of a straight line passing through two points (x₁, y₁)=(168.8013742, 2.32) and (x₂, y₂)=(150.9857815, 1.96) is expressed as y−y₁=k₁(x−x₁), the two points (x₁, y₁) and (x₂, y₂) are substituted into the linear equation y−y₁=k₁(x−x₁) to obtain a slope k₁=0.0202078, and the linear equation of the straight line passing through the two points (x₁, y₁)=(168.8013742, 2.32) and (x₂, y₂)=(150.9857815, 1.96) is obtained based on the slope k₁=0.0202078, and expressed as a formula 1 as follows:

$$y = 0.0202078 ( x - 168.8013742 ) + 2.32 . \qquad ( formula 1 )$$

b. A linear equation of a straight line passing through two points (x₂, y₂)=(150.9857815, 1.96) and (x₃, y₃)=(155.5690009, 2.07) is expressed as y−y₂=k₂(x−x₂), the two points (x₂, y₂) and (x₃, y₃) are substituted into the linear equation y−y₂=k₂(x−x₂) to obtain a slope k₂=0.0240006, and the linear equation of the straight line passing through the two points (x₂, y₂)=(150.9857815, 1.96) and (x₃, y₃)=(155.5690009, 2.07) is obtained based on the slope k₂=0.0240006, and expressed as a formula 2 as follows:

$$y = 0.0240006 ( x - 150.9857815 ) + 1.96 . \qquad ( formula 2 )$$

c. A linear equation of a straight line passing through two points (x₃, y₃)=(155.5690009, 2.07) and (x₄, y₄)=(158.8504315, 2.11) is expressed as y−y₃=k₃(x−x₃), the two points (x₃, y₃) and (x₄, y₄) are substituted into the linear equation y−y₃=k₃(x−x₃) to obtain a slope k₃=0.0121898, and the linear equation of the straight line passing through the two points (x₃, y₃)=(155.5690009, 2.07) and (x₄, y₄)=(158.8504315, 2.11) is obtained based on the slope k₃=0.0121898, and expressed as a formula 3 as follows:

$$y = 0.0121898 ( x - 155.5690009 ) + 2.07 . \qquad ( formula 3 )$$

d. A linear equation of a straight line passing through two points (x₄, y₄)=(158.8504315, 2.11) and (x₅, y₅)=(197.3862395, 2.56) is expressed as y−y₄=k₄(x−x₄), the two points (x₄, y₄) and (x₅, y₅) are substituted into the linear equation y−y₄=k₄(x−x₄) to obtain a slope k₄=0.0116775, and the linear equation of the straight line passing through the two points (x₄, y₄)=(158.8504315, 2.11) and (x₅, y₅)=(197.3862395, 2.56) is obtained based on the slope k₄=0.0116775, and expressed as a formula 4 as follows:

$$y = 0.0116775 ( x - 158.8504315 ) + 2.11 . \qquad ( formula 4 )$$

e. A linear equation of a straight line passing through two points (x₅, y₅)=(197.3862395, 2.56) and (x₆, y₆)=(178.3853437, 2.30) is expressed as y−y₅=k₅ (x−x₅), the two points (x₅, y₅) and (x₆, y₆) are substituted into the linear equation y−y₅=k₅(x−x₅) to obtain a slope k₅=0.0136836, and the linear equation of the straight line passing through the two points (x₅, y₅)=(197.3862395, 2.56) and (x₆, y₆)=(178.3853437, 2.30) is obtained based on the slope k₅=0.0136836, and expressed as a formula 5 as follows:

$$y = 0.0136836 ( x - 197.3862395 ) + 2.56 \qquad ( formula 5 )$$

f. A linear equation of a straight line passing through two points (x₆, y₆)=(178.3853437, 2.30) and (x₇, y₇)=(156.4011937, 1.99) is expressed as y−y₆=k₆ (x−x₆), the two points (x₆, y₆) and (x₇, y₇) are substituted into the linear equation y−y₆=k₆ (x−x₆) to obtain a slope k₆=0.0141011, and the linear equation of the straight line passing through the two points (x₆, y₆)=(178.3853437, 2.30) and (x₇, y₇)=(156.4011937, 1.99) is obtained based on the slope k₆=0.0141011, and expressed as a formula 6 as follows:

$$y = 0.0141011 ( x - 178.3853437 ) + 2.30 . \qquad ( formula 6 )$$

g. A linear equation of a straight line passing through two points (x₇, y₇)=(156.4011937, 1.99) and (x₈, y₈)=(167.0308136, 2.28) is expressed as y−y₇=k₇ (x−x₇), the two points (x₇, y₇) and (x₈, y₈) are substituted into the linear equation y−y₇=k₇ (x−x₇) to obtain a slope k₇=0.0272823, and the linear equation of the straight line passing through the two points (x₇, y₇)=(156.4011937, 1.99) and (x₈, y₈)=(167.0308136, 2.28) is obtained based on the slope k₇=0.0272823, and expressed as a formula 7 as follows:

$$y = 0.0272823 ( x - 156.4011937 ) + 1.99 . \qquad ( formula 7 )$$

h. A linear equation of a straight line passing through two points (x₈, y₈)=(167.0308136, 2.28) and (x₉, y₉)=(217.5375609, 2.65) is expressed as y−y₈=k₈ (x−x₈), the two points (x₈, y₈) and (x₉, y₉) are substituted into the linear equation y−y₈=k₈(x−x₈) to obtain a slope k₈=0.0073258, and the linear equation of the straight line passing through the two points (x₈, y₈)=(167.0308136, 2.28) and (x₉, y₉)=(217.5375609, 2.65) is obtained based on the slope k₈=0.0073258, and expressed as a formula 8 as follows:

$$y = 0.0073258 ( x - 167.0308136 ) + 2.28 . \qquad ( formula 8 )$$

i. A linear equation of a straight line passing through two points (x₉, y₉)=(217.5375609, 2.65) and (x₁₀, y₁₀)=(192.1446012, 2.44) is expressed as y−y₉=k₉(x−x₉), the two points (x₉, y₉) and (x₁₀, y₁₀) are substituted into the linear equation y−y₉=k₉ (x−x₉) to obtain a slope k₉=0.0082700, and the linear equation of the straight line passing through the two points (x₉, y₉)=(217.5375609, 2.65) and (x₁₀, y₁₀)=(192.1446012, 2.44) is obtained based on the slope k₉=0.0082700, and expressed as a formula 9 as follows:

$$y = 0.0082700 ( x - 217.5375609 ) + 2.65 . \qquad ( formula 9 )$$

Finally, the adsorbed gas content is predicted in segment by segment according to the formulas 1-9 and the burial depth (unit is m). When the burial depth is in a range of (3680, 3690), the formula 1 is used for prediction. When the burial depth is in a range of (3690, 3700), the formula 2 is used for prediction, and so on. When the burial depth is in a range of (3760, 3770), the formula 9 is used for prediction to obtain final prediction results of the adsorbed gas contents of the burial depths from 3680 m to 3770 m of the L1 well in the X area, and the final prediction results are shown in Table 2.

TABLE 2
Prediction results of the adsorbed gas contents of the L1 well in the X area

| | Pore specific | Adsorbed | | Pore specific | Adsorbed |
|---|---|---|---|---|---|
| Sampling | surface area | gas content | Sampling | surface area | gas content |
| depth (m) | (μm²/g) | (mL/g) | depth (m) | (μm²/g) | (mL/g) |
| 3680 | 168.8013742 | 2.32 | 3730 | 178.3853437 | 2.30 |
| 3685 | 157.3546371 | 2.09 | 3735 | 176.3537485 | 2.27 |
| 3690 | 150.9857815 | 1.96 | 3740 | 156.4011937 | 1.99 |
| 3695 | 163.2648589 | 2.25 | 3745 | 204.5274823 | 3.30 |
| 3700 | 155.5690009 | 2.07 | 3750 | 167.0308136 | 2.28 |
| 3705 | 149.4537482 | 2.00 | 3755 | 199.3558352 | 2.52 |
| 3710 | 158.8504315 | 2.11 | 3760 | 217.5375609 | 2.65 |
| 3715 | 195.3434673 | 2.54 | 3765 | 210.2537413 | 2.59 |
| 3720 | 197.3862395 | 2.56 | 3770 | 192.1446012 | 2.44 |
| 3725 | 184.4537295 | 2.38 | | | |

The above prediction results are averaged to obtain an average adsorbed gas content of the L1 well in the X area as 2.35 mL/g.

In step S3, relationship formulas between the pore volumes and the free gas contents of the known well are established as a free gas content quantitative prediction model. The pore volumes are expressed as u, and the free gas contents are expressed as v, to thereby form a second discrete series [uᵢ, vᵢ].
a. A linear equation of a straight line passing through two points (u₁, v₁)=(0.22177386, 6.34) and (u₂, v₂)=(0.20228551, 5.69) is expressed as v−v₁=t₁(u−u₁), the two points (u₁, v₁) and (u₂, v₂) are substituted into the linear equation v−v₁=t₁(u−u₁) to obtain a slope t₁=33.35326659, the linear equation of the straight line passing through the two points (u₁, v₁)=(0.22177386, 6.34) and (u₂, v₂)=(0.20228551, 5.69) is obtained based on the slope t₁=33.35326659, and expressed as a formula 10 as follows:

$$v = 33.35326659 ( u - 0.22177386 ) + 6.34 . \qquad ( formula 10 )$$

b. A linear equation of a straight line passing through two points (u₂, v₂)=(0.20228551, 5.69) and (u₃, v₃)=(0.23259485, 6.06) is expressed as v−v₂=t₂(u−u₂), the two points (u₂, v₂) and (u₃, v₃) are substituted into the linear equation v−v₂=t₂(u−u₂) to obtain a slope t₂=12.20745784, and the linear equation of the straight line passing through the two points (u₂, v₂)=(0.20228551, 5.69) and (u₃, v₃)=(0.23259485, 6.06) is obtained based on the slope t₂=12.20745784, and expressed as a formula 11 as follows:

$$v = 12.20745784 ( u - 0.20228551 ) + 5.69 . \qquad ( formula 11 )$$

c. A linear equation of a straight line passing through two points (u₃, v₃)=(0.23259485, 6.06) and (u₄, v₄)=(0.24244343, 6.62) is expressed as v−v₃=t₃(u−u₃), the two points (u₃, v₃) and (u₄, v₄) are substituted into the linear equation v−v₃=t₃(u−u₃) to obtain a slope t₃=56.86101211, and the linear equation of the straight passing through the two points (u₃, v₃)=(0.23259485, 6.06) and (u₄, v₄)=(0.24244343, 6.62) is obtained based on the slope t₃=56.86101211, and expressed as a formula 12 as follows:

$$v = 56.86101211 ( u - 0.23259485 ) + 6.06 . \qquad ( formula 12 )$$

d. A linear equation of a straight line passing through two points (u₄, v₄)=(0.24244343, 6.62) and (u₅, v₅)=(0.27527079, 7.03) is expressed as v−v₄=t₄(u−u₄), the two points (u₄, v₄) and (u₅, v₅) are substituted into the linear equation v−v₄=t₄(u−u₄) to obtain a slope t₄=12.48958124, and the linear equation of the straight line passing through the two points (u₄, v₄)=(0.24244343, 6.62) and (u₅, v₅)=(0.27527079, 7.03) is obtained based on the slope t₄=12.48958124, and expressed as a formula 14 as follows:

$$v = 12.48958124 ( u - 0.24244343 ) + 6.62 . \qquad ( formula 13 )$$

e. A linear equation of a straight line passing through two points (u₅, v₅)=(0.27527079, 7.03) and (u₆, v₆)=(0.18039102, 5.40) is expressed as v−v₅=t₅(u−u₅), the two points (u₅, v₅) and (u₆, v₆) are substituted into the linear equation v−v₅=t₅(u−u₅) to obtain a slope t₅=17.17963707, and the linear equation of the straight line passing through the two points (u₅, v₅)=(0.27527079, 7.03) and (u₆, v₆)=(0.18039102, 5.40) is obtained based on the slope t₅=17.17963707, and expressed as a formula 14 as follows:

$$v = 17.17963707 ( u - 0.27527079 ) + 7.03 . \qquad ( formula 14 )$$

f. A linear equation of a straight line passing through two points (u₆, v₆)=(0.18039102, 5.40) and (u₇, v₇)=(0.23142291, 6.38) is expressed as v−v₆=t₆(u−u₆), the two points (u₆, v₆) and (u₇, v₇) are substituted into the linear equation v−v₆=t₆(u−u₆) to obtain a slope t₆=19.20367903, and the linear equation of the straight line passing through the two points (u₆, v₆)=(0.18039102, 5.40) and (u₇, v₇)=(0.23142291, 6.38) is obtained based on the slope t₆=19.20367903, and expressed as a formula 15 as follows:

$$v = 19.20367903 ( u - 0.18039102 ) + 5.40 . \qquad ( formula 15 )$$

g. A linear equation of a straight line passing through two points (u₇, v₇)=(0.23142291, 6.38) and (u₈, v₈)=(0.26120689, 6.87) is expressed as v−v₇=t₇(u−u₇), the two points (u₇, v₇) and (u₈, v₈) are substituted into the linear equation v−v₇=t₇(u−u₇) to obtain a slope t₇=16.45179623, and the linear equation of the straight line passing through the two points (u₇, v₇)=(0.23142291, 6.38) and (u₈, v₈)=(0.26120689, 6.87) is obtained based on the slope t₇=16.45179623, and expressed as a formula 16 as follows:

$$v = 16.45179623 ( u - 0.23142291 ) + 6 \text{.38} . \qquad ( formula 16 )$$

h. A linear equation of a straight line passing through two points (u₈, v₈)=(0.26120689, 6.87) and (u₉, v₉)=(0.25062694, 6.79) is expressed as v−v₈=t₈(u−u₈), the two points (u₈, v₈) and (u₉, v₉) are substituted into the linear equation v−v₈=t₈(u−u₈) to obtain a slope t₈=7.56146989, and the linear equation of the straight line passing through the two points (u₈, v₈)=(0.26120689, 6.87) and (u₉, v₉)=(0.25062694, 6.79) is obtained based on the slope t₈=7.56146989, and expressed as a formula 17 as follows:

$$v = 7.56146989 ( u - 0.26120689 ) + 6.87 . \qquad ( formula 17 )$$

i. A linear equation of a straight line passing through two points (u₉, v₉)=(0.25062694, 6.79) and (u₁₀, v₁₀)=(0.32218894, 7.27) is expressed as v−v₉=t₉(u−u₉), the two points (u₉, v₉) and (u₁₀, v₁₀) are substituted into the linear equation v−v₉=t₉(u−u₉) to obtain a slope t₉=6.70747021, and the linear equation of the straight line passing through the two points (u₉, v₉)=(0.25062694, 6.79) and (u₁₀, v₁₀)=(0.32218894, 7.27) is obtained based on the slope t₉=6.70747021, and expressed as a formula 18 as follows:

$$v = 6.70747021 ( u - 0.25062694 ) + 6.79 . \qquad ( formula 18 )$$

Finally, the free gas content is predicted in segment by segment according to the formulas 10-18 and the burial depth (unit is m). When the burial depth is in a range of (3680, 3690), the formula 10 is used for prediction. When the burial depth is in a range of (3690, 3700), the formula 11 is used for prediction, and so on. When the burial depth is in a range of (3760, 3770), the formula 18 is used for prediction to obtain final prediction results of the free gas contents of the burial depths from 3680 m to 3770 m of the L1 well in the X area, and the final prediction results are shown in Table 3.

TABLE 3
Prediction results of the free gas contents
of the L1 well in the X area

| Sampling | Pore | Free gas | Sampling | Pore | Free gas |
|---|---|---|---|---|---|
| depth | volume | content | depth | volume | content |
| (m) | (mL/g) | (mL/g) | (m) | (mL/g) | (mL/g) |
| 3680 | 0.22177386 | 6.34 | 3730 | 0.18039102 | 5.40 |
| 3685 | 0.35456384 | 10.77 | 3735 | 0.29638491 | 7.63 |
| 3690 | 0.20228551 | 5.69 | 3740 | 0.23142291 | 6.38 |
| 3695 | 0.29374858 | 6.81 | 3745 | 0.33748595 | 8.12 |
| 3700 | 0.23259485 | 6.06 | 3750 | 0.26120689 | 6.87 |
| 3705 | 0.26648593 | 7.99 | 3755 | 0.28464757 | 7.05 |
| 3710 | 0.24244343 | 6.62 | 3760 | 0.25062694 | 6.79 |
| 3715 | 0.31034647 | 7.47 | 3765 | 0.27394955 | 6.95 |
| 3720 | 0.27527079 | 7.03 | 3770 | 0.32218894 | 7.27 |
| 3725 | 0.21648549 | 6.02 | | | |

The above prediction results are averaged to obtain an average free gas content of the L1 well in the X area as 7.01 mL/g. The average adsorbed gas content is added with the average free gas content to obtain an average total gas content of the L1 well in the X area as 9.36 mL/g.

Similarly, the predicted gas contents of all known wells in the X area are obtained, and the predicted results are shown in Table 4.

TABLE 4
Prediction results of the gas contents
of all known wells in the X area

| | Predicted | Predicted | Predicted |
|---|---|---|---|
| Well | adsorbed gas | free gas | total gas |
| name | content (mL/g) | content (mL/g) | content (mL/g) |
| L1 | 2.35 | 6.68 | 9.36 |
| L2 | 3.5 | 9.39 | 12.89 |
| L3 | 2.96 | 9.06 | 12.02 |
| L4 | 3.23 | 8.51 | 11.74 |
| L5 | 2.61 | 8.9 | 11.51 |
| L6 | 2.46 | 8.98 | 11.44 |
| L7 | 2.41 | 8.45 | 10.87 |
| L8 | 2.39 | 8.39 | 10.78 |
| L9 | 3.41 | 7.13 | 10.55 |
| L10 | 2.43 | 7.91 | 10.34 |
| L11 | 2.51 | 7.58 | 10.09 |
| L12 | 2.22 | 6.71 | 8.93 |
| L13 | 2.17 | 6.76 | 8.93 |
| L14 | 3.28 | 5.27 | 8.55 |
| L15 | 2.1 | 6.29 | 8.39 |
| L16 | 2.19 | 5.49 | 7.68 |
| L17 | 2.19 | 4.91 | 7.10 |

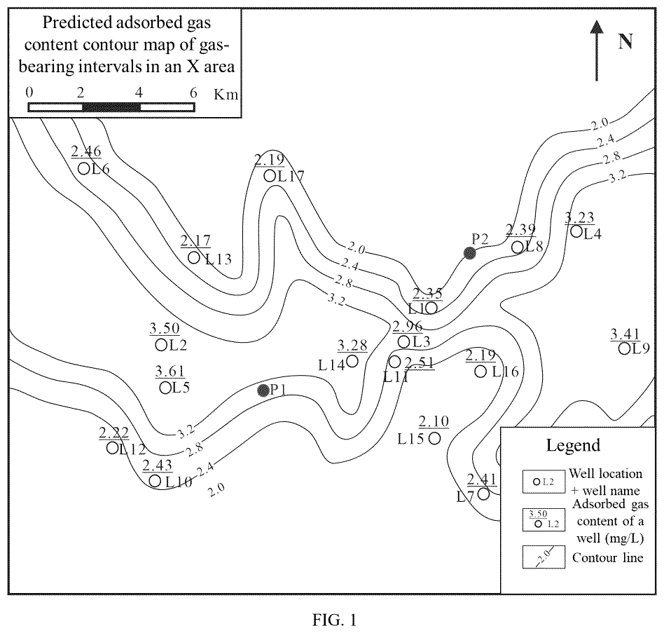

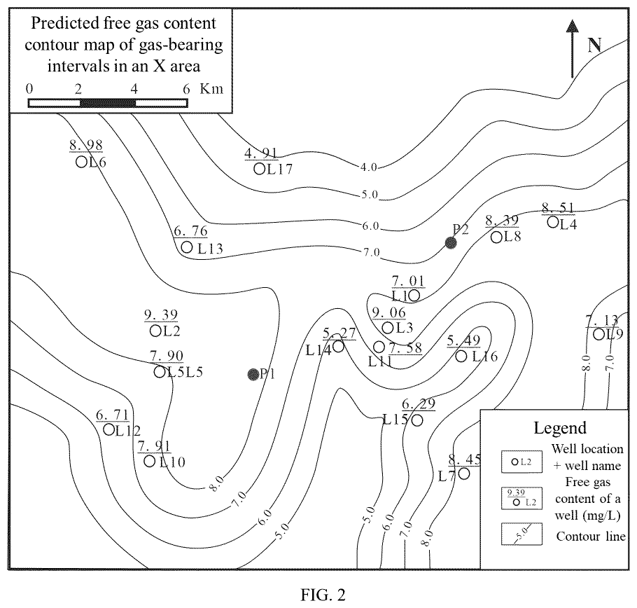

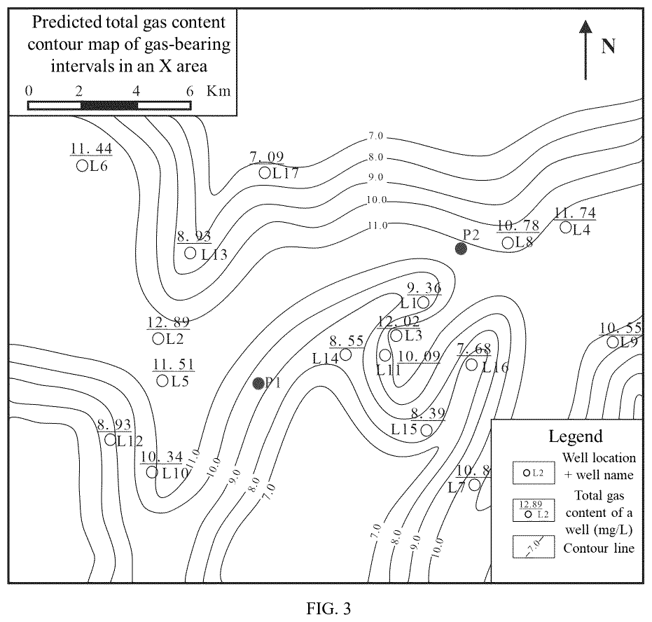

A contour map of predicted adsorbed gas content (as shown in FIG. 1), a contour map of predicted free gas content (as shown in FIG. 2) and a contour map of predicted total gas content (as shown in FIG. 3) of the X area are drawn according to the prediction results of the gas contents of all known wells in the X area.

For any unknown well in the area, an adsorbed gas content, a free gas content and a total gas content of an unknown well in the area are read from the above contour maps. For example, for a P1 well in the X area, it can be seen from FIG. 1 that the P1 well is located between a contour line corresponding to the adsorbed gas content of 2.8 milliliters per gram (mL/g) and a contour line corresponding to the adsorbed gas content of 3.2 mL/g, thus an average between 2.8 mL/g and 3.2 mL/g is used as the adsorbed gas content of the P1 well, that is, the adsorbed gas content of the P1 well is about 3.0 mL/g. Similarly, it can be read from FIG. 2 that the free gas content of the P1 well is about 8.1 mL/g, the total gas content of the P1 well is calculated by summing the adsorbed gas content and the free gas content, and a calculated value of the total gas content is 11.1 mL/g. It can be read from FIG. 3 that a read value of the total gas content is about 9.5 mL/g, and the calculated value and the read value of the total gas content are averaged to obtain the total gas content of the P1 well is 10.3 mL/g.

Similarly, for a P2 well in the X area, it can be read from FIG. 1 that the adsorbed gas content of the P2 well is about 2.0 mL/g, it can be read from FIG. 2 that the free gas content of the P2 well is about 7.0 mL/g, the total gas content of the P2 well is calculated by summing the adsorbed gas content and the free gas content, and a calculated value of the total gas content is 9.0 mL/g. It can be read from FIG. 3 that a read value of the total gas content is about 11.2 mL/g, and the calculated value and the read value of the total gas content are averaged to obtain the total gas content of the P2 well is 10.1 mL/g.

The above description is merely some of the embodiments of the disclosure, and does not limit the disclosure in any form. Although the disclosure has been disclosed in the embodiments, it is not intended to limit the disclosure. Any one of those skilled in the art can use the disclosed technical content to make slight changes or amendments to equivalent embodiments without departing from a scope of the technical solutions of the disclosure. Any simple amendments, equivalent changes, and amendments made to the above embodiments based on the technical essence of the disclosure without departing from the technical solution of the disclosure still belong to the scope of the technical solution of the disclosure.

What is claimed is:

1. A quantitative prediction method for shale gas content, comprising:
S1, obtaining raw data; wherein the raw data comprises adsorbed gas contents, a free gas contents, pore specific surface areas and pore volumes of shale samples at different sampling depths of a known well in an area; and a depth difference between two adjacent sampling depths hᵢ₋₁ and hᵢ of the different sampling depths is 10 m, and i≥2;
S2, establishing, based on the raw data, relationship formulas between the pore specific surfaces areas and the adsorbed gas contents of the known well as an adsorbed gas content quantitative prediction model; wherein the step S2 specifically comprises:
S21, expressing the pore specific surface areas as x, and expressing the adsorbed gas contents as y, to form a first discrete series [xᵢ, yᵢ]; wherein xᵢ represents a pore specific surface area of a shale sample at an i^{th} sampling depth hᵢ of the known well, and yᵢ represents an adsorbed gas content of the shale sample at the i^{th} sampling depth hᵢ of the known well;
S22, obtaining linear equations of straight lines passing through every two adjacent points (xᵢ₋₁, yᵢ₋₁) and (xᵢ, yᵢ) as absorbed gas content prediction formulas corresponding to different burial depths; wherein the step S22 specifically comprises:
(1) expressing a first linear equation of a first straight line passing through two points (x₁, y₁) and (x₂, y₂) as y−y₁=k₁(x−x₁), substituting the two points (x₁, y₁) and (x₂, y₂) into the first linear equation y−y₁=k₁(x−x₁) to obtain a first slope k₁, and obtaining the first linear equation of the first straight line passing through the two points (x₁, y₁) and (x₂, y₂) based on the first slope, expressed as a formula 1 as follows:
$$y = {k}_{1} ( x - {x}_{1} ) + {y}_{1} ; \qquad ( formula 1 )$$
wherein the formula 1 is an adsorbed gas content prediction formula corresponding to a first burial depth range of h₁ to h₂;
(2) expressing a second linear equation of a second straight line passing through two points (x₂, y₂) and (x₃, y₃) as y−y₂=k₂(x−x₂), substituting the two points (x₂, y₂) and (x₃, y₃) into the second linear equation y−y₂=k₂(x−x₂) to obtain a second slope k₂, and obtaining the second linear equation of the second straight line passing through the two points (x₂, y₂) and (x₃, y₃) based on the second slope, expressed as a formula 2 as follows:
$$y = {k}_{2} ( x - {x}_{2} ) + {y}_{2} ; \qquad ( formula 2 )$$
wherein the formula 2 is an adsorbed gas content prediction formula corresponding to a second burial depth range of h₂ to h₃;
(3) expressing a third linear equation of a third straight line passing through two points (x₃, y₃) and (x₄, y₄) as y−y₃=k₃(x−x₃), substituting the two points (x₃, y₃) and (x₄, y₄) into the third linear equation y−y₃=k₃(x−x₃) to obtain a third slope k₃, and obtaining the third linear equation of the third straight line passing through the two points (x₃, y₃) and (x₄, y₄) based on the third slope, expressed as a formula 3 as follows:
$$y = {k}_{3} ( x - {x}_{3} ) + {y}_{3} ; \qquad ( formula 3 )$$
wherein the formula 3 is an adsorbed gas content prediction formula corresponding to a third burial depth range of h₃ to h₄; and
(4) expressing a (i−1)^{th} linear equation of a (i−1)-th straight line passing through every two adjacent points (xᵢ₋₁, yᵢ₋₁) and (xᵢ, yᵢ) as y−yᵢ₋₁=kᵢ₋₁(x−xᵢ₋₁), wherein i≥5, substituting the two points (xᵢ₋₁, yᵢ₋₁) and (xᵢ, yᵢ) into the (i−1)^{th} linear equation y−yᵢ₋₁=kᵢ₋₁(x−xᵢ₋₁) to obtain a (i−1)-th slope kᵢ₋₁, and obtaining the (i−1)-th linear equation of the (i−1)^{th} straight line passing through the two adjacent points (xᵢ₋₁, yᵢ₋₁) and (xᵢ, yᵢ) based on the (i−1)-th slope, expressed as follows:
$$y = {k}_{i - 1} ( x - {x}_{i - 1} ) + {y}_{i - 1} ;$$
wherein the (i−1)-th linear equation y=kᵢ₋₁(x−xᵢ₋₁)+yᵢ₋₁ is an adsorbed gas content prediction formula corresponding to a (i−1)-th burial depth range of hᵢ₋₁ to hᵢ;
S23, predicting, according to the absorbed gas content prediction formulas corresponding to the different burial depths, absorbed gas contents at the different burial depths in segment by segment; and
S24, averaging the adsorbed gas contents at the different burial depths predicted in the step S23 to obtain an adsorbed gas content Qₐ₁ of the known well;
S3, establishing relationship formulas between the pore volumes and the free gas contents of the known well as a free gas content quantitative prediction model; wherein the step S3 specifically comprises:
expressing the pore volumes as u, and expressing the free gas contents as v, to form a second discrete series [uᵢ, vᵢ]; wherein uᵢ represents a pore volume of the shale sample at the i^{th} sampling depth hᵢ, and vᵢ represents a free gas content of the shale sample at the i^{th} sampling depth hᵢ; and
obtaining a free gas content Q_{b1} of the known well according to a same method of the steps S22-S24;
S4, summing the adsorbed gas content Qₐ₁ and the free gas content Q_{b1} to obtain a total gas content Q_{total 1} of the known well;
S5, performing the steps S1-S4 to determine an adsorbed gas content, a free gas content and a total gas content of each of other known wells in the area, to thereby obtain an adsorbed gas content Qₐᵢ, a free gas content Q_{bi} and a total gas content Q_{total i} of each known well in the area; and
S6, drawing a contour map of predicted adsorbed gas content, a contour map of predicted free gas content and a contour map of predicted total gas content of the area according to the adsorbed gas content Qₐᵢ, the free gas content Q_{bi} and the total gas content Q_{total i} of each known well in the area obtained in the step S5; reading a predicted adsorbed gas content Qₐₓ, a predicted free gas content Q_{bx} and a predicted total gas content Q_{total x} of an unknown well in the area from the contour map of predicted adsorbed gas content, the contour map of predicted free gas content and the contour map of predicted total gas content; summing the predicted adsorbed gas content Qₐₓ and the predicted free gas content Q_{bx} of the unknown well in the area to obtain a calculated total gas content Q_{ab} of the unknown well in the area; and averaging the calculated total gas content Q_{ab} and the predicted total gas content Q_{total x} as a total gas content of the unknown well in the area.

2. The quantitative prediction method for shale gas content as claimed in claim 1, wherein in the step S1, each of the adsorbed gas content is obtained by using a methane adsorption isotherm experiment.

3. The quantitative prediction method for shale gas content as claimed in claim 1, wherein in the step S1, each of the total gas contents is obtained by using an on-site testing method based on pressure-holding coring, and each of the free gas contents is a difference between the total gas content and a corresponding one of the adsorbed gas contents.

4. The quantitative prediction method for shale gas content as claimed in claim 1, wherein in the step S1, the pore specific surface areas and the pore volumes are obtained by using at least one selected from the group consisting of a pore structure characterization method based on carbon dioxide adsorption experiment, a pore structure characterization method based on nitrogen adsorption experiment and a pore structure characterization method based on high-pressure mercury injection experiment.
